(19) United States
(12) Patent Application Publication
(10) Pub. No.: US 2012/0210759 A1
(43) Pub. Date: Aug. 23, 2012

(54) Water, Decontaminant and Drying of Vinasse by Micronization and Formulation of an Organic Mineral Fertilizer Made From Vinasse

(75) Inventors: Luis Antonio Stamatis de Arruda Sampaio, Sao Paulo (BR); José Henrique Invitti, Sao Paulo (BR)

(73) Assignee: Biomassa Comercio de Racoes, Energia e Adubos Ltda, Sao Paulo/SP (BR)

(21) Appl. No.: 13/352,857

(22) Filed: Jan. 18, 2012

(30) Foreign Application Priority Data
Jan. 18, 2011 (BR) PI1100645-5

(51) Int. Cl. C05F 5/00

(52) U.S. Cl. 71/23

(57) ABSTRACT

Process for recovery of industrial water, decontamination and drying of vinasse by micronizing procedure and formulation of an organic mineral fertilizer made from vinasse, and more particularly an instant industrial process related to the transformation of vinasse, that is, transformation of the residues from the ethanol production process carried out in the sugar-cane processing plants into an agricultural fertilizer whereof vinasse is initially concentrated in solids through a molecular sieve. The vinasse then concentrated is dried in a micronizing and drying mill equipment and is transformed into a dry powder that, after being properly packed, is generally used as an agricultural fertilizer.

### CROSS REFERENCE TO RELATED APPLICATIONS

This application claims priority to Brazilian Patent Application BR PI1100645-5, filed Jan. 18, 2011, the entire contents of which are herein incorporated by reference.

### FIELD OF INVENTION

This invention relates to an industrial process for transformation of vinasse, and more specifically, relates to the residue components of the ethanol production originated from sugar-cane processing plants.

### BACKGROUND OF THE INVENTION

The industrial and technological developments experienced during the last century brought along a large increase in the consumption of fertilizers, thereby aiding the ever growing need to improve the agricultural yields of crops, and more particularly to supply the increasing demand for food.

It is known to those skilled in the art that vinasse is a stinking slurry residue that remains after sugar-cane broth is leavened and fractionally processed and distilled for obtaining ethanol (ethilic alcohol). For each liter of alcohol produced, 12 liters of vinasse are produced. The vinasse becomes a serious source of pollution when discharged into rivers or soil. Further, the disposal of vinasse is costly, as tank trucks or centrifugal pumps must be used in conjunction with long lines of pipes placed across agricultural production fields. However, they might be employed in farming as a replacement for fertilizers, also might be employed in the production process of biogas as well or used in cattle breeding as an animal foodstuff with a high protein content.

To manufacture fertilizers, basic components are required, such as organic carbon, potassium, nitrogen, phosphorus, sulpher as well as other elements. Properly dosed formulations of these basic elements are prepared in a peculiar piece of equipment, called a micronizing and drying mill.

In the preparation process of fertilizer made from sugar-cane residues, the first step is an adaptation phase of said residues in the form of vinasse. These residues contain organic carbon and significant amounts of potassium organic salts, nitrogen and phosphorus, which must then be processed to remove the water existing in the vinasse. The residue components are found at an average percentage of 97.88% water and 2.12% solids. The solids are made of approximately 1.575% organic matter, including approximately 469 mg/l phenol, 0.3800% potassium, 0.0497% nitrogen, 0.0103% phosphorus, 0.0723% calcium and 0.0333% magnesium.

Therefore, a significant amount of water, at around 80%, must be extracted efficiently and economically so as to avoid the high costs related to vinasse transport to the sugar-cane plantation in order to undergo fertilization. The process of removing most of the existing water is carried out with a membrane fastened to a high intensity vibratory molecular sieve. This equipment is also known as shear force process with vibration application by which the adherence of incrusting substances are avoided due to the intensive vibration applied to the set of osmotic membranes. This process is carried out in a continuous and uniform way with high rates of production when compared to the conventional systems. Conventional systems have to compensate for the lack of the shear force process with vibration application and its advantages, through an increase in membrane area and large fluid rates. This represents a high equipment cost, as well as high operation costs. Additionally, conventional systems require periodic shut down to provide for chemical cleansing, reducing production as a consequence of such interruption.

An additional problem related to the use of gross vinasse in the production of fertilizer is its content of phenol. It is known that the presence of phenol makes the vinasse toxic, and that vinasse causes pollution. As such, its discharge into the environment is restricted by government agencies (Brazilian National Environment Agency CONAMA, Resolution No. 357). The phenol present in the vinasse has an average phenol concentration of 469 mg/l, which is approximately one thousand times higher than the permissible amount of 0.5 mg/l allowed to be discharged as an effluence from industrial process.

Therefore, there is a need in the art for a process that efficiently utilizes concentrated vinasse as a fertilizer.

### SUMMARY OF THE INVENTION

The process described in this instant application solves disposal and economic problems, concentration problems and vinasse destination and as well environmental problems that come from toxicity originating from the presence of phenol in vinasse.

The claimed process in this patent application eliminates phenol through a thorough oxidation with hydrogen peroxide (H₂O₂) using Fenton's reaction. This methods preserves useful organic matter, that is, potassium, phosphorus and nitrogen, in a way that they can be used with no problems. Final removal of water is carried out in a drying mill that is supported by hot gases coming from the sugar-cane plant steam generator steamer.

### BRIEF DESCRIPTION OF THE DRAWINGS

In a way to further support the patent application specification so as to provide a better understanding of the features of the instant claimed invention in accordance with a preferred and practical embodiment of the invention a completed detailed drawing is accompanied with the application in which the execution of the invention is illustrated as a means of exemplification rather than limitation.

FIG. 1 illustrates a production flow chart of the treatment process of vinasse for obtaining a fertilizer.

### DETAILED DESCRIPTION OF THE INVENTION

In accordance with the flow chart the present invention refers to a process for recovery of industrial water, decontamination and drying by micronization of vinasse and formulation of an organic mineral fertilizer made from vinasse and, more specifically, it refers to an industrial process of transformation of vinasse, that is, the transformation of residues coming from the ethanol production processed in the sugar-cane plants.

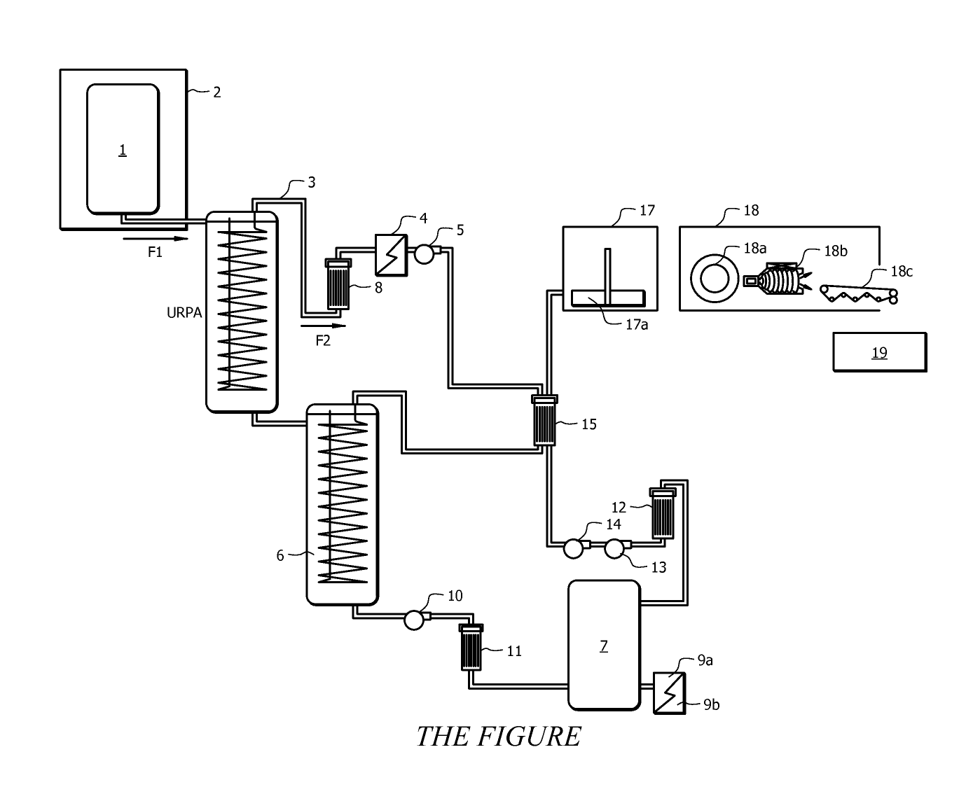

As illustrated in FIGS. 1-6 show vinasse (1) collected from the distillation tower located in the sugar-cane processing plant (2) and proceeds via flow (F1) into the water recovering and fertilizer preparation unit (URFA). The vinasse typically has a temperature of 85° C.-90° C. permitting the use of existing heat from the vinasse to warm up water (3) used to periodically condition the molecular sieve (15). Warmed water (3) is stored in warm water tank (8) at 55° C. The aqueous water flows towards the water heating unit (4) wherein a part of the heat that circulates through piping lines via flow (F2) and through the centrifugal pump (5) is delivered in order to condition the membranes.

Vinasse (1), which has been slightly cooled at this time travels to the cooling tower (6) using ambient air. The vinasse exiting cooling tower (6) travels through centrifugal pump (10) towards filter (11) in the pipe line, thereby removing strange materials from the processing flow. This equipment setup allows for temperature reduction to a desired level of 55° C., as well as a partial removal of water from vinasse (1) by an evaporative process. The vinasse was then transferred to storage tank or hot vinasse tank (7) set to 55° C. Storage tank (7) includes heating/cooling unit (9a and 9b) to maintain the vinasse at a precise 55° C., which is critical for the next step in the process. Instrumentation and control units are used to maintain the exact required temperature, and are visible in the Figures as recycle symbols are marked for heating or cooling procedures. It is noted that variations in temperature, either up or down, will decrease the efficiency and may damage the system.

Vinasse (1) exits storage tank (7) and travels through a filtration unit at point (12) so as to ensure an absolute purity of the fluid before it is pumped towards the molecular sieve. High pressure centrifugal pumps (13) (14) with 40 to 60 bar move the vinasse forward up to the molecular sieve (15). Such high values of pressure are required because of the osmotic pressure on the opposite side which prevents the flow of clean water through the osmotic membrane barrier.

Since osmotic membranes are prone to materials clogging the porous tissues, the process claimed in the present invention uses a molecular sieve (15) set at a high frequency preferably between 53 to 55 Hz. High rates of pure water have been processed from the vinasse using the inventive procedure, such as 5,000 liters water hourly. This provides a great advantage compared to other types of processes since the removal of large amounts of water with high grade of purity has made the claimed process economic and efficient to enable further use of said water.

The result liquid obtained after processing in the molecular sieve (15) is two flows, one of which with very pure water intended for industrial use through a tank and a pump (16) and the other either to be used as replacement water for the cooling towers (6) (6a), as washing water for washing the sugar-cane stems or a replacement water for the steam generator steamers.

At this stage of the process a very high level of recovered water is achieved, normally higher than 80%. The vinasse, now concentrated in a range of 10% total solids, moves ahead to the catalytic oxidation reactor (17) to remove the phenol. This step is necessary since the concentrations of phenol increased during water removal by at least five fold giving rise to a greater problem of disposal of the phenol in the plantation field, as the phenol now greatly exceeds the disposal limit of 469 mg/l of vinasse.

Vinasse (1) travels to oxidation tank (17) provided with a stirring piece (17a) and a continuous supply of hydrogen peroxide, H₂O₂ iron sulphate catalyst FeSO₄ and acidulant H₂SO₄ (sulphuric acid) to adjust pH to three (3). The quantities of reagents are in proportion to the existing content of phenol in dosages slightly higher than that given at stoichiometry so as to ensure a thorough phenol oxidation. It is important to emphasize that the addition of sulphuric acid does not alter the quality of the final products since the chemical reactions will lead to formation of salts with no danger to the environment. In case the condition of chemical neutrality of the product is desired calcium carbonate CaCO₃ may be added so as to reach a pH 7.

Pre-evaporated vinasse of up to 10%, with the phenol removed, travels to a final step to micronize and to remove the water and, if so desired, to possibly add other desired components of fertilizer.

The vinasse travels to micronization equipment (18), which is responsible for the final removal procedure of water from 90% moisture up to 12-15%. The micronizing process gives away a mist or somewhat a fog which is itself water finely micronized (1 to 5 micron) and due to such condition it is maintained hanging on the air, however without being considered as vapor.

Through an internal rotor (18a) that rotates in great speed up above 200 meters per second the water is drew apart from the vinasse in the shape of fine drops (1 to 10 micron). These drops of water together with the solid portions of vinasse are separated using a blast of air through a cyclone apparatus (18b) with a specific configuration. A dry powder now called organic mineral fertilizer (AOM) moves out from the apparatus through a rotating valve and a conveyor (18c) straight away to the packaging unit (19) and storage site for further destination as a fertilizer used in the field. Hot gases from the steamer together with the particulates are added to a drying unit (18) in order to aid in the work of removing the water.

When this phase is finally done gases return to the system of final elimination of particulates so as to avoid any pollution to be caused to the environment. At this point it is now possible to transport the concentrated vinasse to the field and utilize it at once or any other use as a dry powder with a moisture level of 10-15%.

It is important to mention that the concentrate formed as a liquid and with no phenol can be mixed in the soil as a fertilizer and also can be reduced to a powder or to a granulate fertilizer as aforesaid.

It is certain that when the present invention is put to practice modifications might be introduced as it concerns to some details of design and form without departing away from the basic principles that are clearly based on the set of claims and thus it is to be understood that the terminology employed herewith was not intended to limit at all.

In the preceding specification, all documents, acts, or information disclosed does not constitute an admission that the document, act, or information of any combination thereof was publicly available, known to the public, part of the general knowledge in the art, or was known to be relevant to solve any problem at the time of priority.

The disclosures of all publications cited above are expressly incorporated herein by reference, each in its entirety, to the same extent as if each were incorporated by reference individually.

While there has been described and illustrated specific embodiments of a method for manufacturing an organic mineral fertilizer, it will be apparent to those skilled in the art that variations and modifications are possible without deviating from the broad spirit and principle of the present invention. It is also to be understood that the following claims are intended to cover all of the generic and specific features of the invention herein described, and all statements of the scope of the invention which, as a matter of language, might be said to fall therebetween.

What is claimed is:

1.-14. (canceled)

15. A process manufacturing an organic mineral fertilizer comprising the following steps:
providing vinasse from a sugar-cane processing plant;
transferring the vinasse to a water recovery and fertilizer preparation unit;
filtering debris from the vinasse, thereby forming a purified liquid vinasse;
cooling the purified liquid vinasse to a temperature of 55° C.;
flowing the purified liquid vinasse at high pressure through a molecular sieve to form a concentrated vinasse;
transferring the concentrated vinasse to a catalytic oxidation reactor to form a pre-evaporative concentrated vinasse; and
micronizing the pre-evaporative concentrated vinasse to form a fertilizer.

16. The process of claim 15, further comprising transferring heat from the vinasse before it enters the water recovery and fertilizer preparation unit, comprising the steps of:
providing molecular sieve conditioning water;
placing the vinasse adjacent to the molecular sieve conditioning water; and
allowing heat to flow from the vinasse to the molecular sieve conditioning water.

17. The process of claim 16, wherein the heated molecular sieve conditioning water is stored in a warm water tank.

18. The process of claim 16, wherein the temperature of the molecular sieve conditioning water is 55° C.

19. The process of claim 16, wherein the heated molecular sieve conditioning water is pumped through a centrifugal pump to membranes of the molecular sieve to condition the molecular sieve

20. The process of claim 15, wherein the vinasse has a temperature of between 85° C. and 90° C.

21. The process of claim 15, wherein the debris is filtered from the vinasse by flowing the vinasse through a centrifugal pump and into a filter

22. The process of claim 15, wherein the purified liquid vinasse is stored at 55° C. until the purified liquid vinasse is flowed through the molecular sieve to form a concentrated vinasse

23. The process of claim 15, further comprising filtering the purified liquid vinasse before flowing the vinasse at high pressure through the molecular sieve

24. The process of claim 15, wherein the vinasse is flowed at high pressure through the molecular sieve using a plurality of high pressure centrifugal pumps

25. The process of claim 23, wherein the vinasse is flowed at between 40 and 60 bar

26. The process of claim 22, wherein the molecular sieve is set to a frequency between 53 to 55 Hz.

27. The process of claim 15, wherein the catalytic oxidation reactor comprises:
oxidation tank;
a stirring paddle disposed in the oxidation tank; and
a continuous supply of hydrogen peroxide, H2O2 iron sulphate catalyst FeSO4 and H2SO4.

28. The process of claim 27, wherein the catalytic oxidation reactor further comprises calcium carbonate CaCO3 sufficient to reach a pH 7.

29. The process of claim 15, further comprising adding minerals, nutrients, or a combination of minerals and nutrients to the pre-evaporative concentrated vinasse to form the fertilizer.

30. The process of claim 15, wherein the micronizer for forming fertilizer from the pre-evaporative concentrated vinasse further comprises:
a tank;
an internal rotor adapted to rotate at a speed above 200 meters per second;
a source of air adapted to provide a blast of air through to the tank, thereby separating water from the pre-evaporative concentrated vinasse to form the fertilizer; and
a conveyor adapted to transfer the fertilizer from the tank.

31. The process of claim 30, wherein the pre-evaporative concentrated vinasse is transferred to the micronizer, and processed comprising:
rotating the pre-evaporative concentrated vinasse in the tank at a speed above 200 meters per second;
using air to separate the water from the pre-evaporative concentrated vinasse to form the fertilizer; and
transferring the fertilizer from the micronizer.

32. The process of claim 31, wherein the micronizing of the pre-evaporative concentrated vinasse results in a water mist or water fog divided between 1 to 5 micron.

33. The process of claim 15, wherein the micronizing equipment removes 90% of the moisture in the vinasse to achieve a moisture in the vinasse between 12-15%.

34. The process of claim 15, wherein the fertilizer comprises a dry concentrated vinasse with a content of moisture in the range of 10-15%.

35. The process of claim 15, wherein the fertilizer comprises a vinasse in the form of a concentrated liquid free of phenol.
